(19) United States
(12) Patent Application Publication
(10) Pub. No.: US 2007/0279373 A1
(43) Pub. Date: Dec. 6, 2007

(54) Portable electronic apparatus capable of adjusting backlight automatically and adjusting method of backlight thereof

(76) Inventors: Chi-Ming Tseng, Nantou City (TW); Chin-Shu Yao, Jhubei City (TW); Tsung-Hung Lee, Taoyuan City (TW)

Correspondence Address: RABIN & Berdo, PC, 1101 14TH STREET, NW, SUITE 500, WASHINGTON, DC, 20005, US

(21) Appl. No.: 11/797,654

(22) Filed: May 4, 2007

(30) Foreign Application Priority Data
May 5, 2006 (TW) 95116116

(51) Int. Cl. G09G 3/36

(52) U.S. Cl. 345/102

(57) ABSTRACT

A portable electronic apparatus with automatic backlight adjustability and an adjusting method thereof are provided. The portable electronic apparatus comprises a display unit, a storage unit, an image capture unit, a processing unit and a backlight driver. The storage unit is used for storing a backlight parameter table. The image capture unit is used for capturing an image. The processing unit calculates a corresponding exposure value according to the image to obtain a backlight parameter corresponding to the backlight parameter table, and outputs a backlight setting according to the backlight parameter. The backlight driver adjusts the display unit according to the backlight setting to achieve target backlight brightness.

This application claims the benefit of Taiwan application Ser. No. 95,116,116, filed May 5, 2006, the subject matter of which is incorporated herein by reference.

### BACKGROUND OF THE INVENTION

1. Field of the Invention

The invention relates in general to a portable electronic apparatus, and more particularly to a portable electronic apparatus with automatic backlight adjustability and an adjusting method thereof.

2. Description of the Related Art

Referring to FIG. 1, a perspective of a conventional mobile phone is shown. The conventional mobile phone 10 comprises a screen 110 and a keypad 120. When the user would like to change the backlight brightness of the screen 110, the user has to enter into the setting frame to manually set the backlight brightness of the screen 110 via the keypad 120.

The user can not see the contents displayed on the screen 110 if the backlight of the screen 110 is too dark. Therefore, the user has to adjust the backlight of the screen 110 to be brighter in order to see the display contents clearly.

However, the manual setting of the backlight brightness of the screen is time-consuming. Furthermore, as the backlight of the screen becomes brighter, more power will be consumed, and the standby time of the mobile phone will be shortened.

### SUMMARY OF THE INVENTION

The invention is directed to a portable electronic apparatus capable of automatically adjusting the backlight according to environmental brightness and an adjusting method thereof. The portable electronic apparatus automatically adjusts the backlight of a display unit according to the image captured by an image capture unit to save power consumption and increase standby time.

According to a first aspect of the present invention, a portable electronic apparatus is provided. The portable electronic apparatus comprises a display unit, a storage unit, an image capture unit, a processing unit and a backlight driver. The storage unit is used for storing a backlight parameter table. The image capture unit is used for capturing an image. The processing unit calculates a corresponding exposure value according to the image to obtain a backlight parameter corresponding to the backlight parameter table, and outputs a backlight setting according to the backlight parameter. The backlight driver adjusts the display unit according to the backlight setting to achieve target backlight brightness.

According to a second aspect of the present invention, a method of adjusting the backlight of portable electronic apparatus is provided. The portable electronic apparatus comprises a processing unit and a display unit. The backlight driving method comprises the following steps. Firstly, a backlight parameter table is loaded to the processing unit. Next, an image is captured. Then, a corresponding exposure value is calculated according to the image to obtain a backlight parameter corresponding to the backlight parameter table. Lastly, a backlight setting is outputted according to the backlight parameter, and the display unit is adjusted to achieve target backlight brightness.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a perspective of a conventional mobile phone;

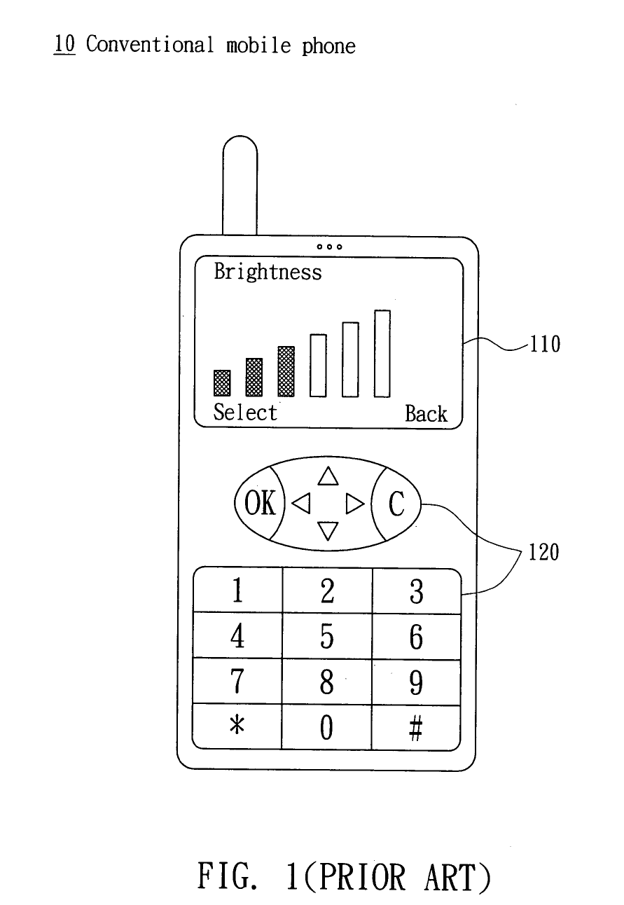

FIG. 2 is a block diagram of a portable electronic apparatus according to a preferred embodiment of the invention;

FIG. 3 is a perspective of a backlight parameter table; and

FIG. 4 is a flowchart of a backlight adjusting method according to a preferred embodiment of the invention.

### DETAILED DESCRIPTION OF THE INVENTION

Normally, the power of the portable electronic apparatus is mostly consumed by the display unit. Therefore, if the backlight brightness of the display unit can be automatically adjusted according to environmental brightness, the power consumption of the portable electronic apparatus is saved and the comfort in viewing is improved.

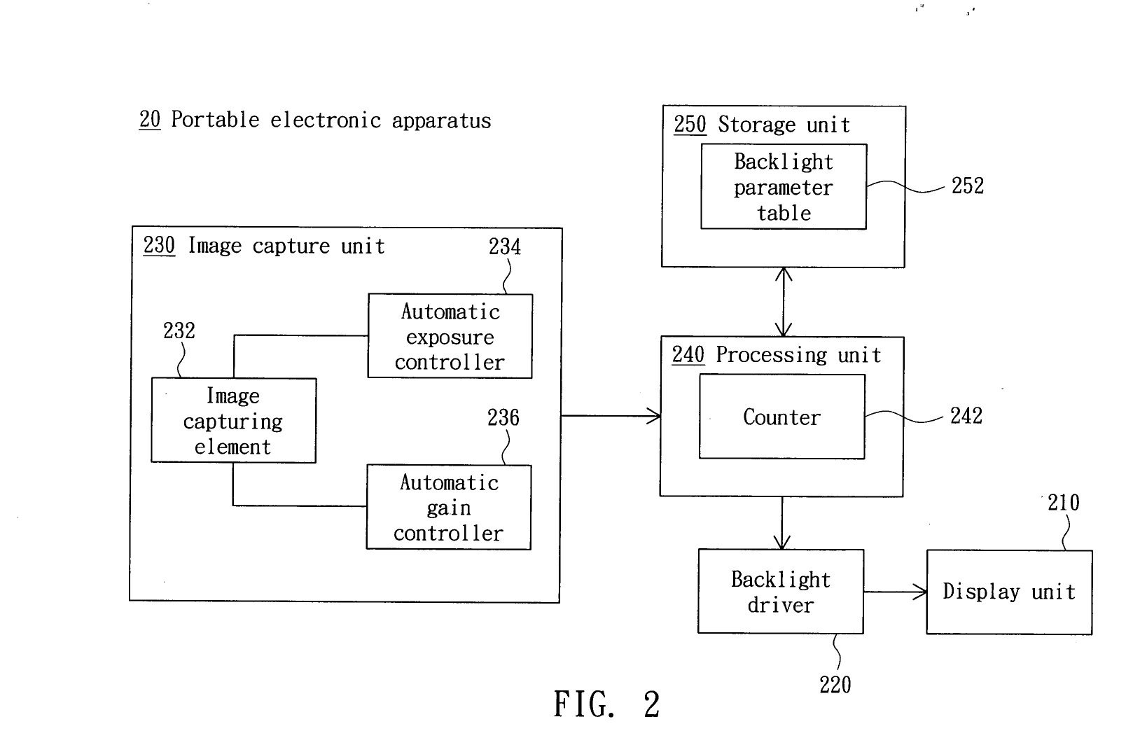

Referring to FIG. 2, a block diagram of a portable electronic apparatus according to a preferred embodiment of the invention is shown. The portable electronic apparatus 20, such as a mobile phone or a personal digital assistant (PDA), comprises a display unit 210, a backlight driver 220, an image capture unit 230, a processing unit 240 and a storage unit 250.

The backlight driver 220, the image capture unit 230 and the storage unit 250 are coupled to the processing unit 240, respectively. The storage unit 250 stores a backlight parameter table 252. The processing unit 240 looks up the backlight parameter table 252 according to the image captured by the image capture unit 230 to output a backlight setting to the backlight driver 220, such that the backlight brightness of the display unit 210 is automatically adjusted, and the power consumption of the portable electronic apparatus 20 is reduced.

Examples of the image capture unit 230 of the portable electronic apparatus 20 include an CMOS camera module. The image capture unit 230 comprises an image capturing element 232, an automatic exposure controller 234 and an automatic gain controller 236. After the automatic backlight adjusting function of the portable electronic apparatus 20 is enabled, the portable electronic apparatus 20 initializes the image capture unit 230. For example, image resolution and frame rate are set, and the automatic exposure controller 234 and the automatic gain controller 236 are enabled.

When the image capturing element 232 captures an image, auto exposure control (AEC) and auto gain control (AGC) are respectively applied to the automatic exposure controller 234 and the automatic gain controller 236 to improve image quality.

For example, when environmental light source turns darker, the automatic exposure controller 234 automatically increases exposure time according to environmental light source to increase frame brightness. The automatic gain controller 236 also automatically changes the gain according to environmental light source to improve frame quality.

To the contrary, when environmental light source turns brighter, the automatic exposure controller 234 automatically reduces the exposure time according to environmental light source, and the automatic gain controller 236 also automatically adjusts the gain according to environmental light source. Therefore, the portable electronic apparatus 20 determines the brightness of environmental light source according to the exposure time and the gain so as to adjust the backlight brightness of the display unit 210.

Besides, after the backlight brightness automatic adjusting function of the portable electronic apparatus 20 is enabled, the portable electronic apparatus 20 also loads the backlight parameter table 252 to the processing unit 240 from the storage unit 250. Examples of the processing unit 240 include multi media processor (MMP).

The processing unit 240 calculates the exposure value of an image according to the exposure time and gain and selects a corresponding backlight parameter from the backlight parameter table 252 to output a backlight setting to the backlight driver 220 for adjusting the display unit 210 to achieve target backlight brightness.

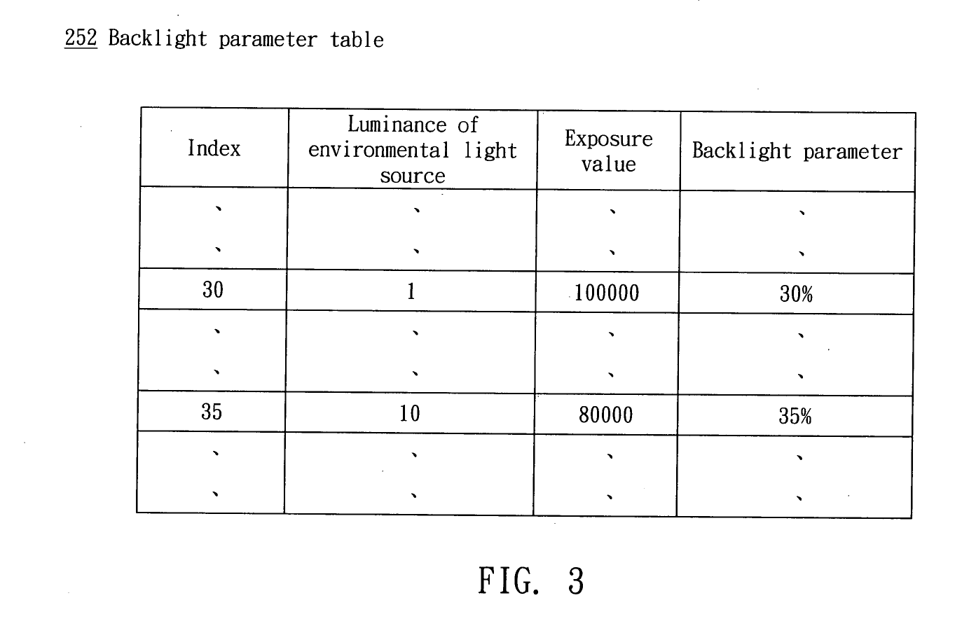

Referring to FIG. 3, a perspective of a backlight parameter table is shown. As the brightness of the environmental light source affects the exposure value of an image, every backlight parameter in the backlight parameter table 252 corresponds to different level of luminance and exposure value. When the processing unit 240 outputs a backlight setting according to the backlight parameter of the backlight parameter table 252 to control the backlight driver 220, the display unit 210 automatically achieves the target backlight brightness according to the brightness of the environmental light source.

The size of the backlight parameter table 252 is determined according to the adjusting range of the backlight brightness. For example, if the adjusting range of the backlight brightness is 0%, 1%˜100%, then the backlight parameter table 252 has 101 backlight parameters. The processing unit 240 selects a corresponding backlight parameter from the backlight parameter table 252 according to the exposure value of the image to correspondingly adjust the display unit 210 so as to achieve the target backlight brightness.

For example, when the luminance of the environmental light source measures 1 lux, the processing unit 240 calculates according to the exposure time and the gain of the image that the exposure value is 100000, and selects that the backlight parameter corresponding to exposure value 100000 is 30%. The processing unit 240 outputs a backlight setting according to the backlight parameter 30% for controlling the backlight driver 220 to adjust the backlight brightness of the display unit 210.

When the luminance of the environmental light source changes to 10 lux, the exposure time and the gain also change with the environmental light source accordingly. The processing unit 240 calculates according to the exposure time and the gain that the exposure value of the image changes to 80000, and selects that the backlight parameter corresponding to exposure value 80000 is 35%. The processing unit 240 further outputs another backlight setting according to the backlight parameter 35% to adjust the backlight brightness of the display unit 210.

The backlight brightness of the display unit 210 is automatically adjusted according to the brightness of the environmental light source, such that better display quality is provided and the power consumption of the portable electronic apparatus 20 is reduced.

To avoid frame flashing which is caused when the backlight brightness is changed too frequently, the processing unit 240 further comprises a counter 242 (as illustrated in FIG. 2). The counter 242, embodied either by software or hardware, is used for counting the number of images outputted to the processing unit 240 by the image capture unit 230. When the counter 242 counts to an upper limit, the processing unit 240 outputs a backlight setting to the backlight driver 220 for enabling the backlight driver 220 to periodically adjust the display unit 210 according to the backlight setting to achieve the target backlight brightness every preset time period. The preset time period is 1˜2 seconds for example.

After the processing unit 240 selects a backlight parameter from the backlight parameter table 252, the backlight parameter is stored in an array. When the counter 242 counts to an upper limit, the processing unit 240 outputs a backlight setting to the backlight driver 220 according to the average of all backlight parameters in the array.

Or, the processing unit 240 outputs a backlight setting to the backlight driver 220 according to the distribution trend of the backlight parameters in the array for enabling the display unit 210 to achieve the target backlight brightness.

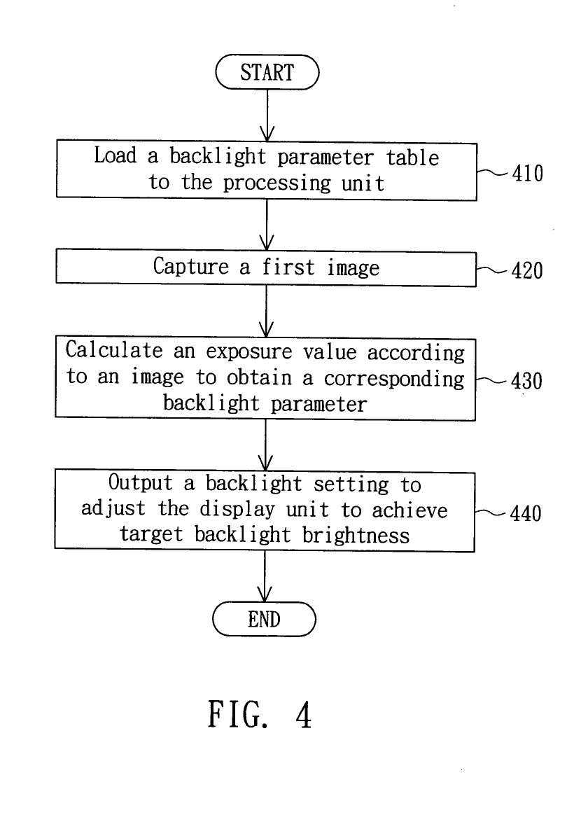

Referring to FIG. 4, a flowchart of a backlight adjusting method according to a preferred embodiment of the invention is shown. The backlight adjusting method used in the portable electronic apparatus 20 comprises the following steps.

Firstly, the method begins at step 410, the portable electronic apparatus 20 loads a backlight parameter table 252 to the processing unit 240 from the storage unit. The portable electronic apparatus 20 also enables the automatic exposure controller 234 and the automatic gain controller 236, and sets image resolution and frame rate.

Next, the method proceeds to step 420, the counter 242 returns to zero, and the image capture unit 230 is used to capture an image.

Then, the method proceeds to step 430, after the image captured by the image capture unit 230 is ready, the processing unit 240 calculates an exposure value according to the exposure time and the gain of the image to obtain a backlight parameter corresponding to the backlight parameter table 252. The processing unit 240 stores the backlight parameter in an array and adds the count of the counter 242 by 1.

Lastly, the method proceeds to step 440, the processing unit 240 determines whether the count of the counter 242 has achieved an upper limit. If the count of the counter 242 achieves the upper limit, the processing unit 240 outputs a backlight setting to the backlight driver 220 according to the backlight parameter stored in the array for adjusting the display unit 210 to achieve the target backlight brightness.

A portable electronic apparatus with automatic backlight adjustability and an adjusting method thereof are disclosed in the above embodiment of the invention. According to the invention, the backlight brightness of the display unit is adjusted correspondingly according to the image captured by the capture unit, not only increasing the user's comfort in viewing the screen, but also effectively reducing the power consumption of the portable electronic apparatus and prolonging the standby time of the portable electronic apparatus.

As the image capture unit has gradually become a standard item of equipment of a portable electronic apparatus to meet consumers' needs, the manufacturers do not need to purchase extra light source sensor, not only saving the space of the portable electronic apparatus, but also avoiding the increase in the cost of the parts.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable electronic apparatus, comprising:
a display unit;
a storage unit used for storing a backlight parameter table;
an image capture unit for capturing a first image;
a processing unit for calculating a corresponding first exposure value according to the first image to obtain a first backlight parameter corresponding to the backlight parameter table, and outputting a backlight setting according to the first backlight parameter; and
a backlight driver for adjusting the display unit according to the backlight setting.

2. The portable electronic apparatus according to claim 1, wherein the image capture unit comprises:
an image capturing element used for capturing the first image;
an automatic exposure controller used for automatically adjusting an exposure time for capturing the first image according to environmental brightness; and
an automatic gain controller automatically adjusting a gain for capturing the first image according to environmental brightness;
wherein, the processing unit calculates the first exposure value according to the exposure time and the gain.

3. The portable electronic apparatus according to claim 1, wherein the processing unit further calculates a corresponding second exposure value according to a second image captured by the image capture unit to obtain a second backlight parameter corresponding to the backlight parameter table and outputs the backlight setting from the first backlight parameter and the second backlight parameter.

4. The portable electronic apparatus according to claim 3, wherein the first backlight parameter and the second backlight parameter are stored in an array.

5. The portable electronic apparatus according to claim 4, wherein the processing unit calculates the average of the first backlight parameter and the second backlight parameter stored in the array to output the backlight setting.

6. The portable electronic apparatus according to claim 4, wherein the processing unit outputs the backlight setting according to the distribution trend of the first backlight parameter and the second backlight parameter stored in the array.

7. The portable electronic apparatus according to claim 1, wherein the backlight driver periodically adjusts the display unit according to the backlight setting every one preset time period to achieve the target backlight brightness.

8. The portable electronic apparatus according to claim 1, wherein the portable electronic apparatus is a mobile phone.

9. The portable electronic apparatus according to claim 1, wherein the portable electronic apparatus is a personal digital assistant (PDA).

10. A method for adjusting the backlight of portable electronic apparatus comprising a processing unit and a display unit, the method comprising:
loading a backlight parameter table to the processing unit;
capturing a first image;
calculating a corresponding first exposure value according to the first image to obtain a first backlight parameter corresponding to the backlight parameter table; and
outputting a backlight setting according to at least the first backlight parameter to adjust the display unit.

11. The method according to claim 10, wherein the first exposure value is obtained according to an exposure time and a gain of the first image, the exposure time and the gain are automatically adjusted according to environmental brightness.

12. The method according to claim 10, further comprising:
capturing a second image;
calculating a corresponding second exposure value according to the second image to obtain a second backlight parameter corresponding to the backlight parameter table; and
outputting the backlight setting from the first backlight parameter and the second backlight parameter.

13. The method according to claim 10, further comprising:
storing the first backlight parameter and the second backlight parameter in an array.

14. The method according to claim 13, wherein the processing unit calculates the average of the first backlight parameter and the second backlight parameter stored in the array to output the backlight setting.

15. The method according to claim 13, wherein the processing unit outputs the backlight setting according to the distribution trend of the first backlight parameter and the second backlight parameter stored in the array.

16. The method according to claim 10, wherein the portable electronic apparatus periodically adjusts the display unit according to the backlight setting every one preset time period to achieve the target backlight brightness

17. The method according to claim 10, wherein the portable electronic apparatus is a mobile phone.

18. The method according to claim 10, wherein the portable electronic apparatus is a personal digital assistant (PDA).
